(19) United States
(12) Patent Application Publication
(10) Pub. No.: US 2025/0145245 A1
(43) Pub. Date: May 8, 2025

(54) Suspension Strut with a Spring Device and a Vibration Damper

(71) Applicant: KTM AG, Mattighofen (AT)

(72) Inventor: Johannes Wimmer, Kastl (DE)

(21) Appl. No.: 18/930,730

(22) Filed: Oct. 29, 2024

(30) Foreign Application Priority Data
Nov. 3, 2023 (DE) 10 2023 130 445.3

(51) Int. Cl. B62K 25/28; B62J 45/20; B62J 45/414; B62J 45/42; B62K 11/00; B62K 25/04

(52) U.S. Cl. CPC B62K 25/283; B62J 45/20; B62J 45/414; B62J 45/42; B62K 11/00; B62K 2025/044

(57) ABSTRACT

A suspension strut system with a spring device and a vibration damper, with a cylinder for receiving damping fluid and a working piston axially movable therein, which is coupled to a piston rod. The working piston divides the cylinder interior into first and second working spaces. Also a valve device for controlling the flow of damping fluid between the first and second working spaces, and an electrically actuated solenoid, which actuates valve means of the valve device for changing a flow passage of the valve device between the first and second working spaces. The suspension strut has a first receptacle having a housing on which the piston rod is supported, and the first receptacle is adapted for arranging the suspension strut on a first body element of a vehicle while the suspension strut has a second receptacle for arranging the suspension strut on a second body element of the vehicle.

### CROSS-REFERENCE TO RELATED APPLICATIONS

This application claims priority to German Patent Application No. 10 2023 130 445.3 filed Nov. 3, 2023, the entire contents of which are incorporated herein by reference.

### BACKGROUND OF THE INVENTION

### Field of the Invention

The present invention relates to a suspension strut with a spring device and a vibration damper with a cylinder configured to receive damping fluid and a working piston axially movable therein. The invention further relates to a system with a suspension strut and a magnet device useable on a motorcycle with a front wheel and a rear wheel and with a driver's saddle and a drive unit and a rear wheel swing arm guiding the rear wheel.

### Background Information

A suspension strut, as mentioned above regarding the field of this invention is, for example, to be arranged on a motorcycle or another vehicle with a driver's saddle, such as, for example, a scooter.

European patent document EP 2 036 746 B1 discloses a sensor module with an acceleration sensor for a shock absorber of a passenger car. The sensor module is provided in a recess of a guide bushing for the piston rod and is arranged on the outside of the shock absorber. European patent document EP 1 964 696 B1 discloses a shock absorber with a position sensor in which an evaluation module is likewise arranged on the outside of the shock absorber, and magnets are arranged on an inside of the inner tube of the shock absorber in the longitudinal direction of the shock absorber. Both arrangements are therefore characterized by the fact that the respective sensor module is arranged on the outside of the outer tube of the respective shock absorber.

Such a configuration is disadvantageous in a motorcycle, especially if it is an off-road sports motorcycle which is exposed to significant external influences, such as, for example, rain and also dirt and possible damage from stones and dust or the like. Even on a street motorcycle, an exposed position of the sensor module on the outer silhouette of the motorcycle is disadvantageous due to exposure to rain and also the risk of damage to the sensor module.

With both types of motorcycle there is also the risk of the signal quality being influenced by the transmission of engine vibrations to the externally arranged sensor module. To influence the damping behavior of such a suspension strut, with the aim of isolating the movement of the motorcycle (and here in particular what are referred to as the rear end or the rear body of the motorcycle in the direction of travel of the motorcycle) from disruptive stimuli—such as, for example, uneven road surfaces and the like—knowledge of the spring travel and the acceleration of the body of the motorcycle in the vertical axial direction of the motorcycle as a result of the stimulus is important to determine the relative velocity and the body velocity, because these values are input parameters for control according to the principle of what is referred to as the “skyhook controller.” The spring travel is here determined as the path that the working piston (or another reference point of the motorcycle) travels within the cylinder or working cylinder as a result of a stimulus when the motorcycle is travelling over an uneven road surface. The relative velocity is then determined by means of a numerical derivation of the spring travel over time; it is therefore necessary to determine the spring travel. According to a known procedure attributable to the applicant, the angle of rotation of the rear wheel swing arm, on which a known suspension strut is supported, is used to determine the spring travel. A permanent magnet is arranged here in the area of the swing arm pivot point, and the magnetic field generated by the permanent magnet is evaluated by means of a sensor device to determine the angle of rotation.

It happens that this procedure for determining the spring travel and the relative velocity has proven successful in practice, but that this procedure still has room for improvement. The place where the angle of rotation of the swing arm is detected (via what is referred to as the swing arm angle sensor) and the sensor device arranged adjacent to it is close to the drive unit (in the form of an internal combustion engine), which results in engine vibrations being transmitted to the sensor unit. The engine vibrations may disrupt the signal quality of the rotation angle signals detected by the sensor device through high-frequency noise. The sensor signal used for the evaluation must be attenuated using numerical filtering. This filtering requires computing time and leads to a time delay, which in turn means that the control of the solenoid to influence the damping behaviour through control of a valve device of the vibration damper takes place with a time offset from the original stimulus.

### SUMMARY OF THE INVENTION

To eliminate the disadvantages described hereinabove, there is provided a suspension strut with a spring device and a vibration damper, which makes it possible to improve the signal quality and reduce the time delay. A motorcycle with such a suspension strut is also to be provided.

The invention provides a suspension strut apparatus with a spring device and a vibration damper, with a cylinder configured to receive damping fluid and a working piston axially movable therein, which is coupled to a piston rod having a longitudinal axis. The working piston divides an interior of the cylinder into a first and a second working space. Included in the apparatus is a valve device adapted to control the flow of damping fluid between the first and second working spaces, and an electrically actuated solenoid which actuates valve means of the valve device for changing a flow passage of the valve device between the first and second working spaces. The suspension strut has a first receptacle having a housing on which the piston rod is supported. The first receptacle is adapted for arranging the suspension strut on a first body element of a vehicle, and the suspension strut has a second receptacle adapted for arranging the suspension strut on a second body element of the vehicle. The suspension strut has a travel measuring device for detecting the current spring travel of the suspension strut, the housing having an inner recess and the travel measuring device having a magneto-operative sensor device arranged in the inner recess, which is adapted to detect a magnetic field of a magnet device spaced apart from the sensor device.

The invention therefore provides a suspension strut with a spring device and a vibration damper. The spring device is, for example, a main spring that radially surrounds the vibration damper. The vibration damper has a cylinder or tubular cylinder which is adapted to receive damping fluid in the form, for example, of a hydraulic oil or fork oil. Arranged to be axially movable in the cylinder is a working piston that is supported on a piston rod which has a longitudinal axis. The working piston divides the interior of the cylinder into a first and a second working space here, the first working space being configured, for example, as a compression chamber and the second working space being configured as a rebound chamber.

The foregoing summary conveys a general understanding of the embodiments of the invention; it is not intended to be limiting.

### BRIEF DESCRIPTION OF THE DRAWINGS

The invention is explained in more detail below with reference to the drawing, in which:

FIG. 1 is a schematic representation of a known device for measuring the swing arm angle;

FIG. 2 is a longitudinal sectional view of an embodiment of a suspension strut according to the present invention;

FIG. 3 is a schematic and perspective representation of the first receptacle of the suspension strut according to FIG. 2, configured as a foot part;

FIG. 4 is a cross-sectional view of the foot part according to FIG. 3;

FIG. 5 is an exploded representation of a travel measuring device according to the present invention;

FIG. 6 is a side view of the foot part according to FIG. 3, illustrating its operation;

FIG. 7 is a schematic and perspective representation of the foot part of the suspension strut with a magnet device arranged on a holder;

FIG. 8 depicts, by way of an excerpt, a schematic and perspective representation of the suspension strut arranged on a rear wheel swing arm of a motorcycle;

FIG. 9 depicts, by way of an excerpt, a schematic and perspective representation of the suspension strut arranged on a deflection with a holder for receiving the magnet device;

FIG. 10 is a representation similar to that of FIG. 9, with a holder configured in one piece with the deflection;

FIG. 11 is a partial sectional view of a suspension strut arranged on a deflection according to the present invention;

FIG. 12 is a diagram comparing raw signals of the spring travel, as are to be provided according to the known procedure and according to the invention; and

FIG. 13 is a side view of a motorcycle with the suspension strut according to the invention.

### DISCLOSURE OF THE SPECIFICATION

There is provided hereby a suspension strut with a spring device and a vibration damper; a motorcycle with such a suspension strut is also to be provided.

The invention provides a suspension strut apparatus with a spring device and a vibration damper, with a cylinder configured to receive damping fluid and a working piston axially movable therein, which is coupled to a piston rod having a longitudinal axis. The working piston divides an interior of the cylinder into a first and a second working space. Included in the apparatus is a valve device adapted to control the flow of damping fluid between the first and second working spaces, and an electrically actuated solenoid that actuates valve means of the valve device for changing a flow passage of the valve device between the first and second working spaces. The suspension strut has a first receptacle having a housing on which the piston rod is supported. The first receptacle is adapted for arranging the suspension strut on a first body element of a vehicle, and the suspension strut has a second receptacle adapted for arranging the suspension strut on a second body element of the vehicle. The suspension strut has a travel measuring device for detecting the current spring travel of the suspension strut, the housing having an inner recess and the travel measuring device having a magneto-operative sensor device arranged in the inner recess, which is adapted to detect a magnetic field of a magnet device spaced apart from the sensor device.

The suspension strut has a spring device and a vibration damper. The spring device is, for example, a main spring radially surrounding the vibration damper. The vibration damper has a cylinder or tubular cylinder adapted to receive a damping fluid such as a hydraulic oil or fork oil. Axially movable in the cylinder is a working piston supported on a piston rod having a longitudinal axis. The working piston divides the interior of the cylinder into a first working space and a second working space. The first working space preferably is configured, for example, as a compression chamber, while the second working space preferably is configured as a rebound chamber.

The vibration damper also has a valve device adapted for controlling the flow of damping fluid between the first and second working spaces, and an electrically actuated solenoid for actuating valve means of the valve device to change a flow passage of the valve device between the first and second working spaces. The one or more valve means are, for example, spring washers or valve shims. These spring washers or valve shims are preferably axially displaced by means of the solenoid via a push rod or pull rod actuated by the solenoid; they thereby close or open a flow cross section or passage between the spring washers and a control edge of the valve device. During the flow movement of the damping fluid through the passage, damping work is performed. By means of such flow's work, a movement of the working piston (as a result of a stimulus caused by the motorcycle travelling over an uneven road surface or the like) is counteracted, i.e., the amplitude of the movement can be reduced.

The suspension strut has a first receptacle with a housing, the piston rod being supported on the first receptacle. The first receptacle preferably is configured as a foot part of the suspension strut. The foot part has a hole or sleeve into which is a bolt may be inserted, by means of which the foot part is, for example, releasably fixed to a rear wheel swing arm of a motorcycle. The foot part, or the receptacle, is therefore configured as a housing for receiving the sleeve; it may be made, for example, from an aluminium alloy by means of a forming process.

The first receptacle is adapted for arranging the suspension strut on a first body element of a vehicle, such as the motorcycle already mentioned. The first body element may be the rear wheel swing arm of the motorcycle, on which the piston rod of the vibration damper is supported. The suspension strut preferably is supported directly on the first body element here, that is to say, on a receptacle of the first body element; or else may be supported with the interposition of kinematics, it being possible for this to be a deflection via which the suspension strut is supported on the rear wheel swing arm or the first receptacle.

The suspension strut also has a second receptacle adapted for arranging the suspension strut on a second body element of the vehicle. (The vehicle can be the motorcycle already mentioned.) The second receptacle has the form of a housing with a sleeve for receiving a bolt or the like with which the second receptacle is releasably arranged on a second body element of the vehicle. This second body element may be, for example, a support or a receptacle on a frame component of the vehicle. In the case of a motorcycle, it is therefore to be a support on the frame of the motorcycle on which the suspension strut is releasably fixed by means of the bolt already mentioned.

The suspension strut has a travel measuring device to detect the current spring travel of the suspension strut. The current value of the spring travel is differentiated over time to determine the relative velocity already mentioned. The relative velocity is used as an input variable for the chassis control of the vehicle—which is, for example, to take place according to the principle of the skyhook controller already mentioned.

Provision is made according to the present apparatus for the housing to have an inner recess, and for the travel measuring device to have a magneto-operative sensor device arranged in the inner recess. The sensor device is adapted to detect a magnetic field of a magnet device spaced apart from the sensor device. Thus, in the suspension strut according to this disclosure, the travel measuring device has a magneto-operative sensor device arranged in the inner recess of the housing which, for example, is to have a Hall sensor or equivalent sensor for detecting a three-dimensional magnetic field. The magnetic field is generated here by a magnet device arranged at a distance from the sensor device and which is, for example, a permanent magnet. A relative movement of the magnet device relative to the sensor device then leads to a change in the induced magnetic field which is detected, for example, by said Hall sensor.

With the travel measuring device arranged within the housing in the inner recess, it is, on the one hand, protected from disruptive environmental influences (such as dust, dirt and water) and is, on the other hand, also protected by the housing against disruptive influences, such as the engine vibrations mentioned above. As previously mentioned herein, such engine vibrations may superimpose high-frequency noise on the travel signal of the sensor device or the Hall sensor, which must be filtered out by means of signal processing so to improve the signal quality of the travel signal. The configuration of the suspension strut according to the present apparatus ensures that less high-frequency noise is superimposed on the raw signal of the sensor device in the form of the travel signal; that is to say, the spring travel signal and the signal quality of the raw signal are therefore improved.

Because the raw signal is already significantly less noisy, the effort involved in numerical signal processing of the raw signal is reduced. More particularly, the effort involved in filtering the travel signal from the raw signal decreases considerably, which reduces the time required for post-processing the raw signal to determine the travel signal. And since the spring travel signal is a real-time signal of the current spring travel of the suspension strut, the time delay caused by the numerical post-processing of the real-time signal therefore decreases until a current value for the current supply to the solenoid is produced from the real-time signal to change the flow cross-section or the flow passage the valve device. For example, the time required to obtain the travel signal from the raw signal drops from about 30 milliseconds to about 3 milliseconds. The chassis control that is hence possible by influencing the damping behaviour of the vibration damper therefore corresponds to real-time control with nearly no time delay. The reduction of the time delay thus leads to an improvement in the control strategy for the purpose of determining damping behaviour of the vibration damper that is currently required (or desired) by the driver of the vehicle—and thus to an increase in convenience when driving the vehicle.

If the magnet device changes its position relative to the sensor device, which is continuously the case while the vehicle equipped with the suspension strut is travelling, the magnetic field of the magnet device detected by the sensor device also changes. For example, if the magnet device performs a rotational movement relative to the sensor device, the change in the magnetic field is detected and evaluated by the sensor device. The evaluation typically takes place in the form of angular degrees due to the abovementioned rotational movement of the magnet device relative to the sensor device. The relative rotational movement of the magnet device leads, starting from a first angular degree value present at time t, to a second angular degree value present at time t1. The rotational movement therefore leads to a difference in the angular degree values that are determined. From known geometric data of the vehicle and of the suspension strut, the spring travel resulting along the longitudinal axis of the piston rod during the relative rotational movement of the magnet device is therefore can be determined. Using a numerical derivation of the spring travel over time, the relative velocity, which represents an input parameter for the abovementioned suspension control, is therefore also determined.

According to a refinement of the invention, provision is made for the travel measuring device to be releasably fixed in the inner recess and to have a circuit board with at least one Hall sensor. Also, the inner recess may be cast with a casting compound. This configuration means that the sensor device is protected against external interference, and the signal quality of the Hall sensor is therefore improved.

According to a refinement of the invention, provision is also made for the sensor device to have an acceleration sensor for detecting the acceleration of the longitudinal axis of the suspension strut, and for the sensor device to be adapted to transmit the detected acceleration to an evaluation device. When the magnet device moves relative to the sensor device with one or more than one sensor element, the magnetic field detected by the sensor element (or elements) changes, as mentioned above. The position of the magnet device therefore represents a reference point for the sensor device, the change in position of which is detected by the sensor device by means of the sensor element or elements; this gives the spring travel travelled Sᵣₑₗ and from this, in turn, the relative velocity Vᵣₑₗ of the compression movement can be determined via the numerical derivation of the spring travel over time.

The body velocity V_{body} of the motorcycle body is determined by additionally detecting the value of the body acceleration a_{body} of the motorcycle body by means of an acceleration sensor and numerical integration over time. The values determined this way are then used to determine the minimum damping Cₘᵢₙ and the maximum damping Cₘₐₓ, from which the desired damping c for damping the compression movement is determined according to the following skyhook controller relationship:

$$\begin{matrix}{c}_{min} if {v}_{body} \cdot {v}_{rel} \leq 0 \\ {c}_{max} if {v}_{body} \cdot {v}_{rel} > 0\end{matrix}$$

The circuit board preferably is a circuit board having conductor tracks for supplying with electrical energy the Hall sensor or sensors arranged thereon. The circuit board also has connection elements for connecting connection lines for introducing electrical energy. The circuit board preferably is arranged in the housing together with the Hall sensor or sensors (i.e., in the inner recess of the housing), the inner recess preferably being cast with a casting compound after the circuit board has been arranged with the Hall sensors. The casting compound ensures that the circuit board with the Hall sensors is held securely in the housing and is also protected against impacts, shocks, or vibrations that originate at an internal combustion engine of the motorcycle. This also reduces the influence of high-frequency noise on the sensor signal. The quality of the signals emitted by the Hall sensors via conductor tracks on the circuit board which result from the detection of the abovementioned magnetic field therefore is improved. Also arranged on the abovementioned printed circuit board is the acceleration sensor already mentioned, with which the acceleration of the body of the motorcycle is detected; such acceleration is included in the abovementioned skyhook control to determine the desired damping. The travel signals and the acceleration signal are passed via lines arranged on the printed circuit board and connection lines that are connected on the circuit board, for example as a pulse wave modulated signal, to an evaluation device which may be a chassis controller.

According to a refinement of the invention, provision is also made for the sensor device to have a connection means for supplying current to the electrically actuated solenoid. The connection means are, for example, connection lines which have already been explained above and via which, in addition to supplying current to the sensor device, signals determined by the sensor device are also passed to the evaluation device. Furthermore, through this functional integration and the feature of the invention that the piston rod is supported on the first receptacle—which also receives the travel measuring device according to the invention and from which the connection lines are also led out—the connection means or connection lines for supplying current to the solenoid are routed through the piston rod to the solenoid. This means that the connection means for supplying current to the solenoid are also protected against external interference, as they are arranged within the piston rod and thus also within the cylinder of the vibration damper.

According to a refinement of the invention, provision is also made for the housing composed of a formed plastic material and to have a passage for receiving electrical connection means. The abovementioned printed circuit board, having the 3D Hall sensor and an acceleration sensor, is arranged in the plastic housing and is protected by a casting compound. In addition, the housing has a passage for receiving the electrical connection means, via which the solenoid is also to be supplied with current and the sensors are to be supplied with electrical energy and, in addition, the values or sensor signals provided by the sensors are issued and are passed to an evaluation device in the form of the chassis controller already mentioned above.

The present invention also includes a system with a suspension strut, as has been explained in detail above, and with a magnet device, the magnet device being arranged on a rear wheel swing arm of a motorcycle. This means that the magnet device is, for example, arranged directly on the upper side of a motorcycle's rear wheel swing arm, lying at the top when viewed in the vertical axial direction of the motorcycle, directly adjacent to a flange surface or connection surface for arranging the first receptacle of the suspension strut.

When the motorcycle travels over an uneven road surface, the rear wheel swing arm undergoes pivotal movement on a frame component of the motorcycle and is supported here on the suspension strut according to the invention. The first receptacle of the suspension strut is arranged adjacent to the magnet device, i.e., in a way that the magnet device undergoes a circular segment-shaped, or arcuate, relative movement relative to the sensor device of the travel measuring device. The magnetic field of the magnet device that changes during the relative movement is detected by the sensor device in the form of the angle signals already mentioned. These signals are then forwarded to the evaluation device in the form of the chassis controller already mentioned by way of example. In addition to these angle signals, acceleration signals are also transmitted via the sensor device, these representing the acceleration of the longitudinal axis of the piston rod; they are likewise forwarded to the evaluation device. The evaluation device then numerically integrates the acceleration signals to determine therefrom the body velocity of the motorcycle.

The spring travel calculated from the angle signals is derived over time to determine the relative velocity, which is then evaluated together with the body velocity according to the abovementioned “skyhook rule” to determine the desired damping. The current damping value determined this way is used to supply current to the solenoid so that the solenoid is connected to current for a predetermined period of time in turn to change the flow passage of the valve device.

The invention also provides a system with a suspension strut, as explained above, and with a magnet device, the magnet device being arranged on a holder. The holder is, for example, to be a holder arranged on a deflection and is to receive the magnet device. When the suspension strut undergoes spring movements, the holder with the magnet device performs circular segment-shaped movements relative to the sensor device arranged in the inner recess in the first receptacle of the suspension strut. In this way, the magnetic field that changes due to the relative movement of the magnet device is detected by the sensor device, and evaluated to provide the abovementioned sensor signals. In this embodiment too, the body movement of the motorcycle is detected and evaluated to determine the abovementioned acceleration signals.

The invention disclosed hereby also provides a motorcycle (with a front and rear wheels, a driver's saddle, a drive unit, and a rear wheel swing arm guiding the rear wheel) with a system as mentioned above and a magnet device arranged on the rear wheel swing arm, a pivoting movement of the rear wheel swing arm resulting in a circular or circular segment-shaped (arcuate) relative movement of the magnet device relative to the sensor device. This circular or circular segment-shaped relative movement of the magnet device relative to the sensor device leads to the abovementioned change in the magnetic field of the magnet device, which is detected by the sensor device and forwarded to the evaluation device in the form of sensor signals, as has been mentioned above.

The invention also provides a motorcycle with a system with a holder, as has been mentioned above, and a magnet device arranged on the holder, the pivoting movement of the rear wheel swing arm resulting in a circular or circular segment-shaped relative movement of the magnet device relative to the sensor device. The holder is, for example, arranged on a deflection on which the suspension strut is supported. This circular or circular segment-shaped (arcuate) relative movement of the magnet device relative to the sensor device leads to the abovementioned change in the magnetic field of the magnet device, which is detected by the sensor device and forwarded to the evaluation device in the form of sensor signals, as mentioned above.

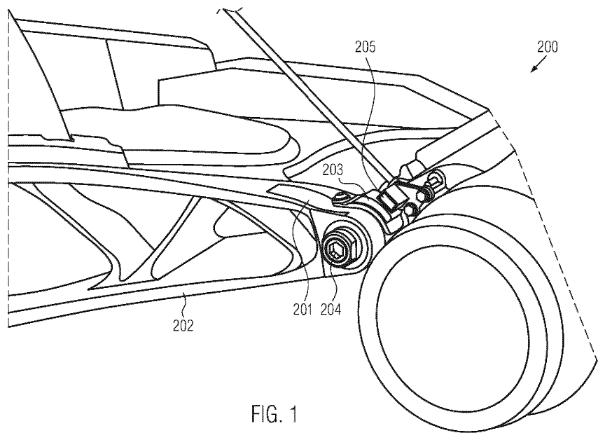

Attention is invited to FIG. 1 of the drawing, showing a schematic representation of a device 200 (attributable to the applicant) for detecting the swing arm angle. The device 200 comprises a permanent magnet 203 arranged on a top side 201 of a rear wheel swing arm 202, which magnet is to pivot together with the rear wheel swing arm 202 about a pivot point 204 at which the rear wheel swing arm 202 is arranged on a component of the motorcycle (not shown in more detail). The pivoting movement of the rear wheel swing arm 202 at the pivot point 204 leads to a change in the relative position of the permanent magnet 204 relative to a swing arm angle sensor 205.

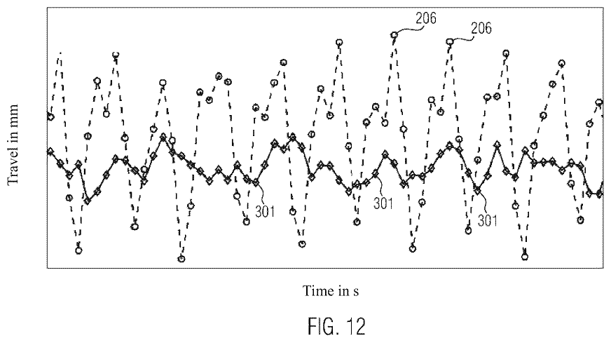

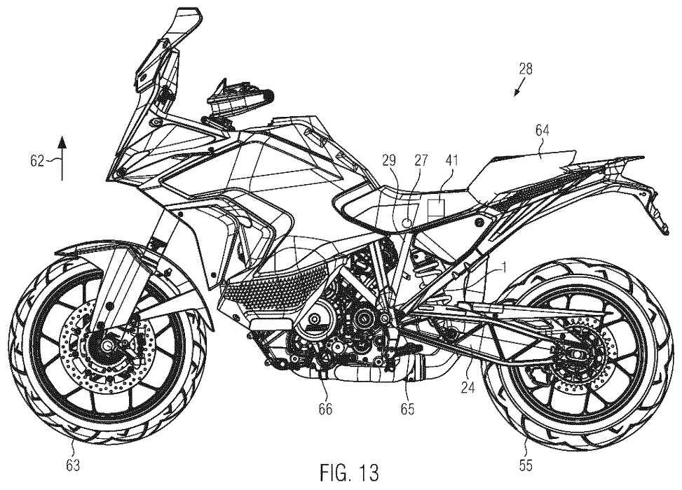

With this known device 200, the measured values 206 shown in the graph of FIG. 12 relating to the spring travel are detected in millimeters (mm) recorded over time in seconds(s). As is apparent, these measured values have a relatively large spread compared to an average value. The large spread is due, inter alia, to high-frequency noise induced by the engine vibrations of the motorcycle's internal combustion engine, this influence being further increased in the numerical differentiation of the travel signals to determine a velocity signal.

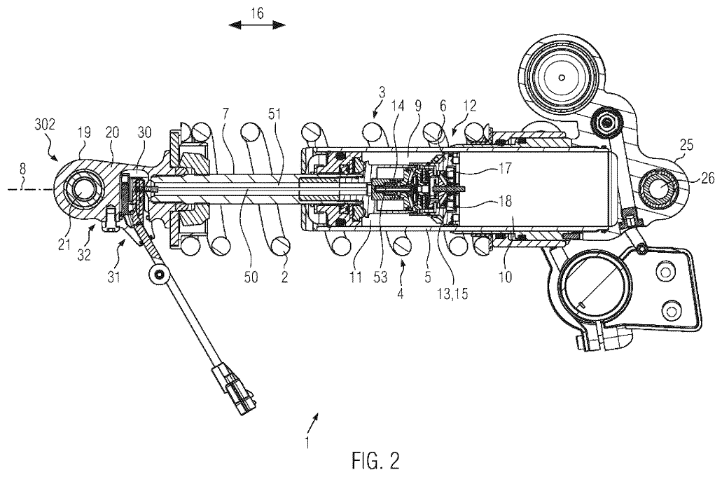

FIG. 2 of the drawing shows a longitudinal sectional view of a suspension strut 1 according to an embodiment according to the present invention. The suspension strut 1 has a spring device 3 configured as a main spring 2 and has a vibration damper 4 configured to receive damping fluid (not shown in the drawing) such as fork oil or known hydraulic oil. The vibration damper 4 has a cylinder 5, which in the illustrated embodiment of the suspension strut 1 is configured as a tubular cylinder; in addition, the vibration damper 4 also has a working piston 6 axially movable in the cylinder 5 and which performs damping work in conjunction with the damping fluid.

The working piston 6 is coupled to a piston rod 7, i.e., to the piston rod 7, which has a longitudinal axis 8. The working piston 6 divides an interior 9 of the cylinder 5 into a first working space 10 and a second working space 11. The first working space 10 also is referred to as a compression chamber, and the second working space 11 is also referred to as a rebound chamber. Damping oil located in the compression chamber is put under pressure during the compression movement of the suspension strut 1, and damping oil located in the rebound chamber is pressurized during the rebound movement of the suspension strut 1.

The vibration damper 4 has a valve device 12 with valve means 15 in the form of spring shims or valve shims 13. The shims 13 are actuated by the electrically actuated solenoid 14, that is to say, they are displaced in the axial longitudinal direction 16 of the cylinder 5 to control the flow of damping fluid between the first working space 10 and the second working space 11 by changing the cross-sectional area 17 of a flow passage 18. The damping work performed by the working piston 6 is controlled by changing the cross-sectional area 17 through which the damping fluid flows, in order to flow between the first working space 10 and the second working space 11.

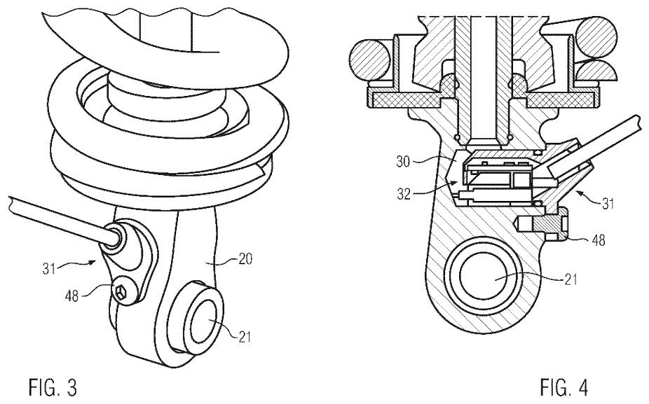

The suspension strut 1 has a first receptacle 19, as seen from FIG. 2, the first receptacle 19 having a housing 20 on which the piston rod 7 is supported. The first receptacle has a recess 21, as also seen in FIGS. 3 and 4, which is penetrable by a bolt 22—as seen, for example, from FIG. 9—and the support of the suspension strut 1 serves its purpose on a first body element 23 (which is, for example, the rear wheel swing arm 24 shown in FIG. 8). The suspension strut 1 is therefore supported via the first receptacle 19 on the rear wheel swing arm 24, for example, by means of a bolt shown in more detail in FIG. 8 (which corresponds to the bolt 22 according to FIG. 9).

The suspension strut 1 also has a second receptacle 25 with a recess 26, which serves to receive a bolt with which the suspension strut 1 is supported on a second body element 27 of the vehicle (e.g., the motorcycle 28 shown in FIG. 13). The second body element 27 is a frame component 29 in the motorcycle 28, as seen from FIG. 13.

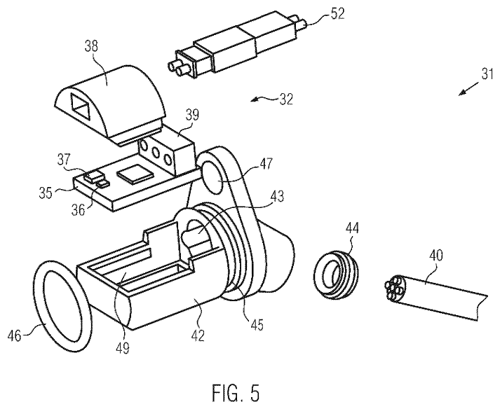

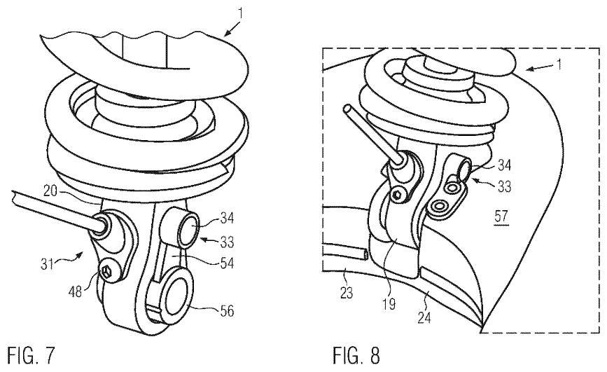

FIG. 2 shows that the housing 20 has an inner recess 30 in which a travel measuring device 31 is arranged; the latter has a magneto-operative sensor device 32 (as seen in more detail in FIG. 5) adapted to detect a magnetic field of a magnet device 33 spaced apart from the sensor device 32. The magnet device 33 is seen, for example, in FIGS. 7 and 8. The magnet device 33 preferably is a permanent magnet 34.

FIG. 5 illustrates an exploded view of the travel measuring device 31. The travel measuring device 31 is arranged in the inner recess 30 of the housing 20—in particular in a releasably fixed manner as seen in FIG. 2 of the drawing—and has a sensor device 32. The travel measuring device 31 has the sensor device 32, which has a circuit board or printed circuit board 35 on which a Hall sensor 36 is arranged. An acceleration sensor 37 is also arranged on the circuit board 35, and is adapted to measure the acceleration of the piston rod 7 along the longitudinal axis 8. The circuit board 35 is covered by a closure cap 38 which spans the circuit board 35. Additionally, the circuit board 35 has a connection socket 39 to which the connection means 40 are connected, which connection means serve to supply power to the circuit board 35 with the sensors 36, 37—and via which the sensor signals from the sensors 36 and 37 are also routed to an evaluation device 41 (as seen from FIG. 13) which is a chassis controller.

The circuit board 35 is received in a housing 42 formed of a plastic material and which has a passage 43 for receiving the connection means 40. The sleeve 44 serves to receive the connection means 40 and to fix the connection means 40 in the passage 43. An O-ring 46, which seals the inner recess 30 towards the outside, is placed in a groove 45 of the plastic housing 42.

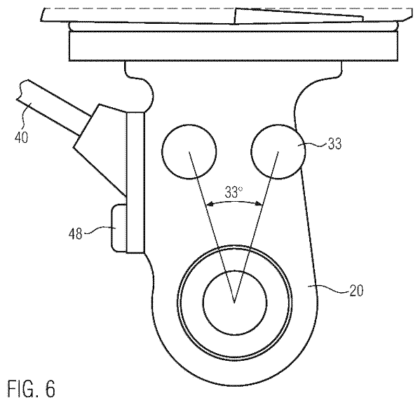

The housing 42 arranged in the inner recess 30 is releasably fixed via the recess 47 shown in FIG. 5 by means of a screw 48 shown in FIG. 6; the inner recess 30 or the inner recess 49 of the housing 42 or both inner recesses preferably being cast with a casting compound so that the circuit board 35 and/or the housing 42 are protected against the ingress of dirt and water.

The solenoid 14 is supplied with electrical energy via the connection lines or connection means 52, for example, via an electrical line 50 arranged in an inner recess 51 of the piston rod 7.

FIG. 3 shows that the travel measuring device 31 is arranged with the sensor device 32 in the housing 20; the sectional representation according to FIG. 4 illustrates that the connection lines 52 for supplying the solenoid 14 with electrical energy are also arranged in the inner recess 30 of the housing 20, and are enclosed by a casting compound (not shown in more detail).

FIG. 6 is a side view of the foot part according to FIG. 3 to explain how it works. As seen from the schematic representation according to FIG. 6, the magnet device 33 undergoes an arcuate, or a circular segment-shaped, movement when the rear wheel swing arm 24 pivots relative to the housing 20, and thus relative to the sensor device 32 arranged in the housing. The pivot angle in the illustrated embodiment is 33 degrees.

The sensor device 32 uses the 3D Hall sensor 36 to detect the magnetic field that changes due to the relative movement of the magnet 33. The detection signals of the sensor 36 are forwarded to the evaluation device 41 of the motorcycle 28 via the connection means 40. The evaluation device 41 uses this to determine the respectively current spring travel of the suspension strut 1 in real time. Additionally, the acceleration of the unsprung mass of the rear wheel 55 of the motorcycle 28 is detected via the acceleration sensor 37; these signals are also forwarded to the evaluation device 41. The evaluation device uses said signals to determine the desired damping c for the compression movement or rebound movement of the suspension strut 1, and supply current to the solenoid 14 to change the flow passage 18. Consequently, the armature 53 of the solenoid 14 is displaced along the longitudinal axis 8 of the suspension strut 1, and the spring shims 13 are therefore also displaced and the flow cross section 17 of the flow passage 18 is increased or decreased; the damping work performed by the vibration damper 4 is therefore increased or decreased and the damping with which the vibration damper 4 counteracts the spring movement of the suspension strut 1 is therefore increased or decreased.

FIG. 7 shows that the magnet device 34 is arranged on a holder 54 which, together with the pivot bearing 56, pivots relative to the receptacle 20, and therefore relative to the travel measuring device 31 during the spring movement of the suspension strut 1. FIG. 8 shows how the magnet device 33 is arranged directly on an upper side 57 of the rear wheel swing arm 24.

Reference to FIG. 9 shows a configuration in which the suspension strut 1 is supported on a deflection 58, which in turn is supported on a rear wheel swing arm 24. The pivoting movement of the rear wheel swing arm 24 then causes the deflection 58 to pivot together with the holder 54 of the pivot bearing 56, i.e., relative to the housing 20 of the suspension strut 1 in which the travel measuring device 31 is arranged. A permanent magnet (not shown in more detail in FIG. 9) is arranged in the receiving eye 59 of the holder 54, the magnetic field of which permanent magnet acts on the sensor device 31 which is arranged in the housing 20.

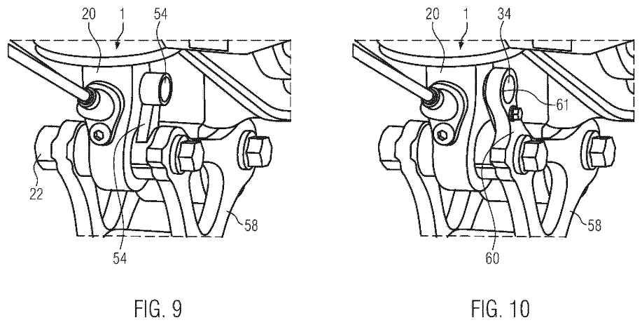

FIG. 10 shows a holder 60 configured in one piece with the deflection 58 and in whose receiving eye 61 a permanent magnet 34 is arranged. During the pivoting movement of the rear wheel swing arm (not shown in detail in FIG. 10) relative to the suspension strut 1, the magnetic field exerted by the permanent magnet 34 therefore changes relative to the travel measuring device 31, which is detected by the sensor device 31 as has been explained.

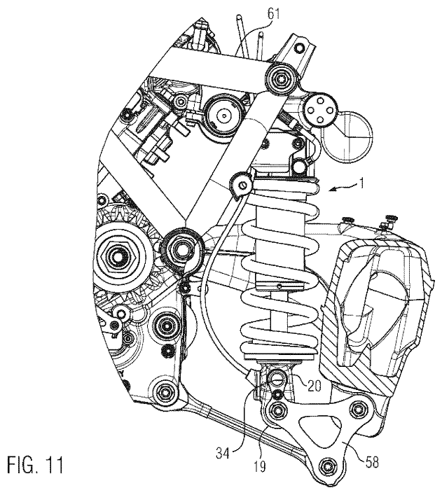

FIG. 11 shows a partial sectional view of a suspension strut 1 arranged on a deflection according to the present invention. The suspension strut 1 is supported with the first receptacle 19 on the deflection 58. In addition, the suspension strut 1 is supported with the second receptacle 25 on a frame boom 61. A permanent magnet 34 is arranged in the holder 54 and, during the pivoting movement of the rear wheel swing arm relative to the suspension strut 1, performs a circular segment-shaped or arcuate movement, as has been explained with reference to FIG. 6. The magnetic field that changes during the relative movement of the permanent magnet 20 relative to the housing 20 with the travel measuring device 31 is detected by the sensor device 31; the resulting signals are transmitted to the evaluation device 41, as previously discussed.

Attention is advanced to FIG. 12, a diagrammatic graph with the raw signal measured values 206 already explained above, as obtained with the known configuration 200 with the swing arm angle sensor 205. In comparison, the raw signal measured values 301, as obtained with the suspension strut 1 according to the invention with the travel measuring device 31 integrated in the housing 20 or the foot part 302, show a significantly smaller spread than the spread of the measured values 206.

The travel measuring device 31 according to the invention, or the suspension strut 1 according to the invention, shows, with the travel measuring device 31 integrated in the foot part 302 of the suspension strut 1, a significantly lower noise in the raw signal, this being expressed by the significantly smaller spread of the raw signal 301. This means that the raw signal 301 must be filtered significantly less than the raw signal 206 to determine the spring travel. This leads to a time advantage when post-processing the raw signal 301, because the numerical effort involved in filtering the signal is reduced, and thus also the computing time required for the post-processing. This in turn leads to a shorter time delay in the real-time control of the damping provided by the vibration damper.

Finally, FIG. 13 depicts a motorcycle 28 with a front wheel 63 as well as a driver's saddle 64, and a drive unit 66 in the form of an internal combustion engine. The rear wheel swing arm 24 is supported on the swing arm pivot point 65 and pivots thereon. The rear wheel swing arm 24 is supported on the suspension strut 1 according to the invention and the spring travel of the suspension strut 1, which occurs when the rear wheel swing arm 24 pivots, is detected by means of the suspension strut 1, as has been explained in detail above.

The configuration of the suspension strut according to the invention ensures a circular segment-shaped relative movement of the permanent magnet relative to the Hall sensor of the sensor device. The Hall sensor is therefore to precisely determine the position of the permanent magnet in real time and at any time. The position signal determined in this way is converted into an angle and forwarded to the evaluation device in the form, for example, of a chassis controller. In addition, the acceleration sensor records the acceleration in the direction of the longitudinal axis of the suspension strut and this acceleration signal also is forwarded to the evaluation device. Both signals are processed to produce a relative velocity signal of the vibration damper for real-time control. In addition, both signals are also evaluated to determine the body movements of the motorcycle in the direction of the vertical axis 62 according to FIG. 13 and the movement of the rear wheel 55 of the motorcycle 28.

With regard to features of the invention that have not specifically been explained in more detail above, reference is otherwise expressly made to the patent claims and the drawing.

### LIST OF REFERENCE NUMERALS

1. Suspension strut
2. Main spring
3. Spring device
4. Vibration damper
5. Cylinder
6. Working piston
7. Piston rod
8. Longitudinal axis
9. Interior
10. First working space
11. Second working space
12. Valve device
13. Spring shims
14. Solenoid
15. Valve means
16. Axial longitudinal direction
17. Cross-sectional area
18. Flow passage
19. First receptacle
20. Housing
21. Recess
22. Bolt
23. First body element
24. Rear wheel swing arm
25. Second receptacle
26. Recess
27. Second body element
28. Motorcycle
29. Frame component
30. Inner recess
31. Travel measuring device
32. Sensor device
33. Magnet device
34. Permanent magnet
35. Circuit board
36. Hall sensor
37. Acceleration sensor
38. Closure cap
39. Connection socket
40. Connection means
41. Evaluation device
42. Housing
43. Passage
44. Sleeve
45. Groove
46. O-ring
47. Recess
48. Screw
49. Inner recess
50. Electrical lines
51. Inner recess
52. Connection lines
53. Armature
54. Holder
55. Rear wheel
56. Pivot bearing
57. Upper side
58. Deflection
59. Receiving eye
60. Holder
61. Frame boom
62. Vertical axis
63. Front wheel
64. Driver's saddle
65. Swing arm pivot point
66. Drive unit, internal combustion engine
200. Device
201. Upper side
202. Rear wheel swing arm
203. Permanent magnet
204. Pivot point
205. Swing arm angle sensor
206. Measured values
301. Raw signal measured values
302. Foot part

What is claimed is:

1. A suspension strut with a spring device and a vibration damper with a cylinder configured to receive damping fluid and a working piston axially movable therein, which is coupled to a piston rod having a longitudinal axis, the working piston dividing an interior of the cylinder into a first working space and a second working space, and with a valve device adapted to control the flow of damping fluid between the first and second working spaces, and an electrically actuated solenoid for actuating valve means of the valve device for changing a flow passage of the valve device between the first and second working spaces, the suspension strut having a first receptacle having a housing, on which the piston rod is supported, the first receptacle adapted for arranging the suspension strut on a first body element of a vehicle, the suspension strut having a second receptacle adapted for arranging the suspension strut on a second body element of the vehicle, the suspension strut having a travel measuring device for detecting the current spring travel of the suspension strut, wherein the housing has an inner recess and the travel measuring device has a magneto-operative sensor device, arranged in the inner recess, adapted to detect a magnetic field of a magnet device spaced apart from the sensor device.

2. The suspension strut according to claim 1 wherein:
the travel measuring device is releasably fixed in the inner recess and has a circuit board with at least one Hall sensor; and
the inner recess is cast with a casting compound.

3. The suspension strut according to claim 1 wherein the sensor device comprises an acceleration sensor for detecting the acceleration of the longitudinal axis of the suspension strut, and further wherein the sensor device transmits the detected acceleration to an evaluation device.

4. The suspension strut according to claim 1 wherein the sensor device has a connection means for supplying current to the electrically actuated solenoid.

5. The suspension strut according to claim 1 wherein the housing comprises a plastic material and defines a passage for receiving electrical connection means.

6. The suspension strut according to claim 1 operative with a magnet device disposed on a rear wheel swing arm of a motorcycle.

7. The suspension strut according to claim 1 operative with a magnet device arranged on a holder.

8. The suspension strut according to claim 6 in a motorcycle having:
a front wheel;
a rear wheel;
a driver's saddle;
a drive unit; and
a rear wheel swing arm guiding the rear wheel; and
further comprising a magnet device arranged on the rear wheel swing arm, wherein a pivoting movement of the rear wheel swing arm induces an arcuate movement of the magnet device relative to the sensor device.

9. The suspension strut according to claim 7 in a motorcycle having:
a front wheel;
a rear wheel;
a driver's saddle;
a drive unit; and
a rear wheel swing arm guiding the rear wheel; and
further comprising a magnet device arranged on the holder, wherein a pivoting movement of the rear wheel swing arm induces an arcuate movement of the magnet device relative to the sensor device.
